(19) United States
(12) Patent Application Publication
(10) Pub. No.: US 2026/0341830 A1
(43) Pub. Date: Oct. 29, 2026

(54) BATTERY SYSTEMS WITH THERMAL FUSE FOR ENHANCED THERMAL SAFETY

(71) Applicant: Enphase Energy, Inc., Fremont, CA (US)

(72) Inventors: Vikram Nandakumar IYENGAR, Austin, TX (US); Wei JIANG, Round Rock, TX (US); Christopher McNair LYKE, Austin, TX (US); Conner O’Grady FEAR, Glen Ellen, CA (US)

(21) Appl. No.: 19/484,062

(22) PCT Filed: May 16, 2024
(86) PCT No.: PCT/US2024/029561

§ 371 Date: Nov. 13, 2025

Related U.S. Application Data
(60) Provisional application No. 63/467,168, filed on May 17, 2023.

(51) Int. Cl. H01M 10/653; H01M 10/627; H01M 10/658; H01M 50/207; H01M 50/251; H01M 50/264

(52) U.S. Cl. CPC H01M 10/653; H01M 10/627; H01M 10/658; H01M 50/207; H01M 50/251; H01M 50/264

(57) ABSTRACT

The present disclosure provides an energy storage system. For example, an energy storage system a chassis; a battery module comprising a plurality of battery cells and a thermal interface material disposed between a wall of the chassis and the plurality of battery cells such that if a temperature within the chassis is less than a predetermined temperature, the thermal interface material transfers heat to the wall of the chassis, and if the temperature within the chassis is equal to or greater than the predetermined temperature, the thermal interface material creates a thermal barrier that blocks heat from a hotter cell of the plurality of battery cells to the ambient and to other cells of the plurality of battery cells.

### BACKGROUND

### Field of the Disclosure

Embodiments of the present disclosure relate generally to energy storage systems, and, for example, to energy storage systems comprising battery systems with a thermal fuse for enhanced thermal safety.

### Description of the Related Art

Energy storage systems configured for use with energy management systems are known. For example, cell-to-system designs can use a metal chassis for reducing cost and simplifying an assembling process. In such designs, one or more battery cells, e.g., prismatic cells, can be transported to and secured in the chassis. Typically, a bottom of the one or more battery cells will contact the back plate of the chassis, with a layer of thermally conductive materials between the bottom of the one or more battery cells and the back plate. The thermally conductive materials can have a desired dielectric property to provide a needed electrical insulation.

In normal operation, heat from the one or more battery cells is dissipated from the sides of the one or more battery cells through the thermally conductive materials and the metal chassis to the ambient. If there is a thermal runaway from one or more of the battery cells, however, a thermal conduction pathway can lead to two potential issues. For example, heat from the thermal runaway from one or more of the battery cells may heat the metal chassis and the heat will be further transferred to the wall and the surroundings, which may cause the failure of passing the chassis surface and wall temperature limits of the UL9540A (e.g., thermal runway fire propagation testing). Additionally, heat from the thermal runaway from one or more of the battery cells may be transferred through a heat spreader plate to neighboring cells in the same subpack or neighboring subpacks and, thus, increase the chance of thermal runaway of neighboring cells.

Accordingly, there is a need for improved energy storage systems comprising battery systems with a thermal fuse for enhanced thermal safety.

### SUMMARY

Energy storage systems are provided herein. For example, in some embodiments, an energy storage system comprises a chassis, a battery module comprising a plurality of battery cells, and a thermal interface material disposed between a wall of the chassis and the plurality of battery cells such that if a temperature within the chassis is less than a predetermined temperature, the thermal interface material transfers heat to the wall of the chassis, and if a temperature within the chassis is equal to or greater than the predetermined temperature, the thermal interface material creates a thermal barrier that blocks heat from a hotter cell of the plurality of battery cells to the ambient and to other cells of the plurality of battery cells.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of chassis comprising a PCBA with a battery module disconnected and configured for use with the energy management system of FIG. 1, in accordance with one or more embodiments of the present disclosure; and FIG. 3 is a diagram of the chassis of FIG. 2 with the battery module connected, in accordance with one or more embodiments of the present disclosure.

### DETAILED DESCRIPTION

Embodiments of the present disclosure relate to improved energy storage systems comprising battery systems with a thermal fuse for enhanced thermal safety. For example, in at least some embodiments, an energy storage system comprises a chassis, a battery module comprising a plurality of battery cells, and a thermal interface material disposed between a wall of the chassis and the plurality of battery cells. Thus, if a temperature within the chassis is less than a predetermined temperature, the thermal interface material transfers heat to the wall of the chassis, and if a temperature within the chassis is equal to or greater than the predetermined temperature, the thermal interface material creates a thermal barrier that blocks heat from a hotter cell of the plurality of battery cells to the ambient and to other cells of the plurality of battery cells. The apparatus described herein meets NFPA855 requirements regarding installation in enclosed space, which leads to increased market penetration/share and, therefore, increased revenue.

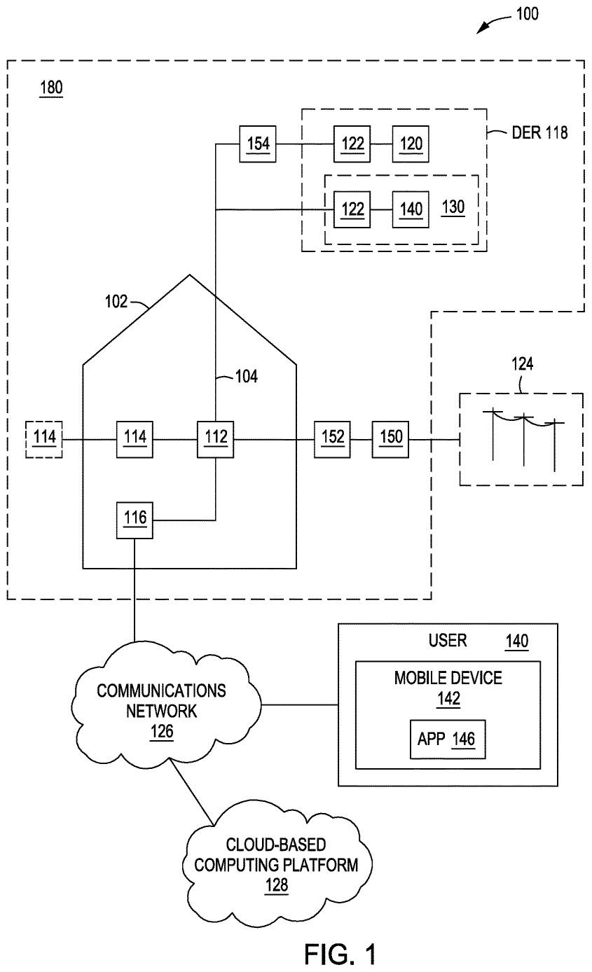

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries convert AC power from the AC bus 104 to DC power for charging the batteries. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

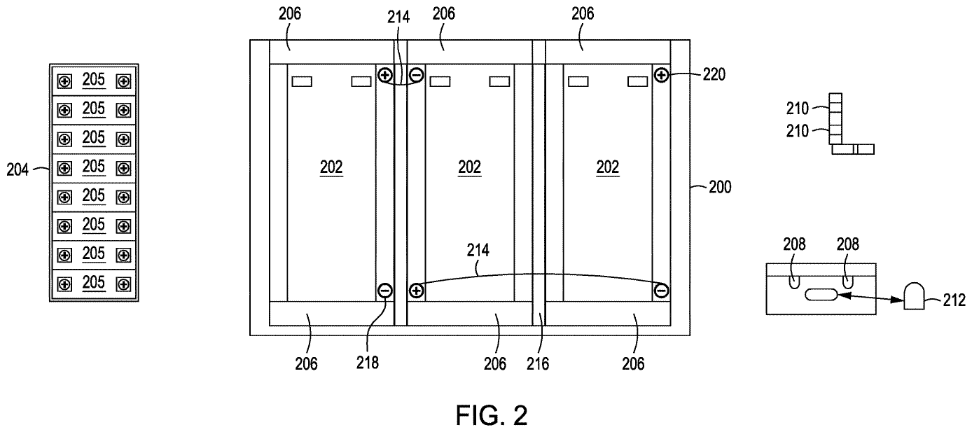

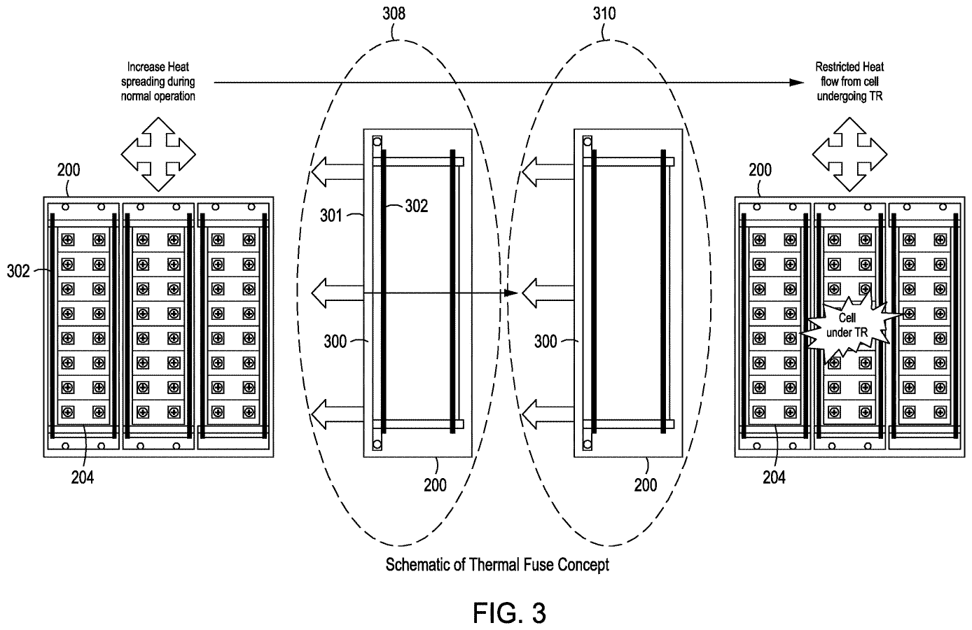

FIG. 2 is a diagram of chassis 200 comprising a PCBA 202 with a battery module disconnected and configured for use with the energy management system of FIG. 1, and FIG. 3 is a diagram of the chassis of FIG. 2 with the battery module connected, in accordance with one or more embodiments of the present disclosure. For example, the chassis 200 can be configured for use with one or more energy storage devices (e.g., the energy storage system 114), such as the storage system disclosed in commonly-owned U.S. patent application Ser. No. 17/145,793, filed Jan. 11, 2021 and entitled “Storage System Configured For Use With An Energy Management System,” the entire contents of which is incorporated herein by reference.

The chassis 200 can be configured to house one or more types of battery pack configurations. For example, the chassis 200 can be configured to house prismatic battery packs, cylindrical battery packs, and/or pouch battery packs. In FIGS. 2 and 3 the chassis 200 can be configured for use with prismatic battery packs and cylindrical battery packs. For illustrative purposes, the chassis 200 is described configured for use with prismatic battery packs.

For example, unlike conventional chassis that are configured to house a battery pack comprising a plurality of battery cells, the chassis 200 (e.g., AC battery 130) is configured to house one or more battery modules 204 (e.g., one or more sub-battery packs) comprising one or more battery cells 205, which can be connected in series via a bus bar (not shown). For example, each battery module of the one or more battery modules 204 can comprise 1, 2, 3, 4, etc. battery cells. For example, each battery module of the one or more battery modules 204 can comprise up to twelve battery cells, sometimes more. Each battery module of the one or more battery modules 204 can comprise the same number of battery cells or a different number of battery cells. In the illustrated embodiment, each battery module of the one or more battery modules 204 is shown comprising eight battery cells that are held in place via one more connecting/disconnecting apparatus.

For example, each battery module of the one or more battery modules 204 is held in place by a pair of end plates 206. For example, each end plate of the pair of end plates 206 has a plurality of apertures 208 that extend along a horizontal plane of each end plate. Similarly, each end plate of the pair of end plates 206 has a plurality of apertures 210 that extend along a vertical plane of each end plate. The plurality of apertures 208 that extend along the horizontal plane of each end plate are configured to receive a corresponding screw that is used to connect each end plate to an inner wall of the chassis 200. The plurality of apertures 210 that extend along the vertical plane of each end plate are configured to receive the rod 302 (FIG. 3). In at least some embodiments, each end of the rod 302 is threaded and configured to receive a corresponding screw (or nut) that when tighten compresses the pair of end plates 206 toward each other, as will be described in greater detail below. Alternatively, one end of the rod 302 can be threaded and configured to receive the corresponding screw and the other end of the rod 302 can have a flange with a diameter greater than the apertures 210. In use, the rod 302 goes through each end plate of the pair of end plates 206, so that after being fastened with the screws and/or nuts, the rod 302, screws/nuts, and the pair of end plates 206 together apply pressure to the plurality of battery cells 205 and hold the plurality of battery cells 205 together to form the battery module 204.

A lifting structure 212 can be provided on each end plate of the pair of end plates 206 to facilitate taking the battery module 204 in/out of the chassis 200. In at least some embodiments, the lifting structure 212 can be configured for grasping by a hand or fingers of a user.

One or more types of separating material 216 (or compression material) can be provided between adjacent battery modules of the one or more battery modules 204. The separating material 216 is configured to provide a predetermined amount of separation between the adjacent battery modules of the one or more battery modules 204. In at least some embodiments, the separating material 216 can be aerogel, silicon rubber, polymer nanocomposites, etc. Additionally, one or more thermal interface materials can be disposed within the chassis 200, as described in greater detail below.

The PCBA 202 is configured to connect/disconnect via voltage (V) and temperature (T) sensing components to the battery module 204. For example, the voltage (V) and temperature (T) sensing components connect to battery tabs of the battery module 204 via screw or welding. The PCBA 202 provides battery status information (V and T) to a battery management unit/system (BMU/S) which could be on a PCU. For example, the V and T sensing components allow the PCBA 202 to sense voltage and temperature and/or current of the battery module 204. Additionally, the PCBA 202 has current paths to optimize cable routing inside the chassis 200. For example, the cables 214 can be used to connect a positive terminal on a battery module to a negative terminal on another battery module (e.g., an adjacent battery module). In at least some embodiments, a negative terminal 218 on a battery module (e.g., a first battery module in the series connection) and a positive terminal 220 on a battery module (e.g., a last battery module in the series connection) can connect to the BMU/S (or PCU).

As described above, optimized thermal management is needed to achieve optimal product performance, longer battery life, and better customer experience, and limiting thermal runaway propagation is critical. For example, UL9540A sets limits on battery system surface temperature and wall temperature, and too much heat emitted from a rear (or rear wall) (e.g., heat spreader plate) of the chassis may cause failure of meeting the limits required by UL9540A. Similarly, NFPA855 has limits on the amount of gas that a battery system is allowed to release during thermal runaway when the battery system is installed in an enclosed space. Accordingly, being unable to control a number of battery cells going to thermal runaway can lead to increased gas volume that is generated, which, in turn, can limit a location where a battery system can be installed and can lead to reduced revenue. Thus, the inventors have found that special thermally conductive materials can function as a thermal fuse at elevated temperatures. For example, the special thermally conductive materials can function as normal thermal pathways in normal operation for optimal thermal management of a battery. Additionally, the special thermally conductive materials become a thermal barrier during thermal runaway to block the heat generated from a battery cell undergoing thermal runaway to the rear of the chassis.

FIG. 3 is a diagram of the chassis of FIG. 2 with the battery module connected, in accordance with one or more embodiments of the present disclosure. For example, as noted above, a thermal interface material 300 can be disposed between a rear of a chassis (e.g., the chassis 200) and a plurality of battery cells (e.g., the one or more battery cells 205). The thermal interface material 300 has high thermal conductivity at normal operation to enhance battery heat dissipation and achieve better performance/life. Conversely, the thermal interface material 300 has low thermal conductivity at thermal runaway to reduce heat transfer between battery cells (through the metal chassis of the battery module) to mitigate the risk of cell-to-cell thermal runaway propagation. Accordingly, if a temperature within the chassis 200 is less than a predetermined temperature, the thermal interface material 300 transfers heat to a rear 301 (e.g., heat spreader plate) of the chassis 200 (during normal operation, as illustrated by the three directional arrows in diagram 308). Conversely, if a temperature within the chassis 200 is equal to or greater than the predetermined temperature, the thermal interface material 300 creates a thermal barrier that blocks heat from a hotter cell of the plurality of battery cells to the ambient and to other cells of the plurality of battery cells. The thermal interface material 300 can comprise or be composed of highly conductive polymers (e.g., ultra-high molecular weight polyethylene (UHMWPE)) that are ineffective above a certain temperature, which may be due to melting or charring that reduces their conductivity.

While the foregoing is directed to embodiments of the present disclosure, other and further embodiments of the disclosure may be devised without departing from the basic scope thereof, and the scope thereof is determined by the claims that follow.

1. An energy storage system, comprising:
a chassis;
a battery module comprising a plurality of battery cells; and
a thermal interface material disposed between a rear of the chassis and the plurality of battery cells such that if a temperature within the chassis is less than a predetermined temperature, the thermal interface material transfers heat to the rear of the chassis, and if the temperature within the chassis is equal to or greater than the predetermined temperature, the thermal interface material creates a thermal barrier that blocks heat from a hotter cell of the plurality of battery cells to the ambient and to other cells of the plurality of battery cells.

2. The energy storage system of claim 1, wherein the thermal interface material comprises a highly conductive polymer.

3. The energy storage system of claim 2 wherein the highly conductive polymer is ultra-high molecular weight polyethylene (UHMWPE).

4. The energy storage system of claim 1, wherein the battery module is one of a prismatic battery pack, a cylindrical battery pack, or a pouch battery pack.

5. The energy storage system of claim 1, wherein the battery module comprises eight to twelve battery cells.

6. The energy storage system of claim 1, wherein the plurality of battery cells are held in place via one more connecting/disconnecting apparatus.

7. The energy storage system of claim 1, wherein the one more connecting/disconnecting apparatus a pair of end plates.

8. The energy storage system of claim 1, wherein the thermal interface material has a high thermal conductivity at normal operation to enhance heat dissipation and achieve better performance/life of the battery module.

9. The energy storage system of claim 1, wherein the thermal interface material has a low thermal conductivity at thermal runaway to reduce heat transfer between the plurality of battery cells to mitigate cell-to-cell thermal runaway propagation.
